(19) United States
(12) Patent Application Publication
(10) Pub. No.: US 2021/0097637 A1
(43) Pub. Date: Apr. 1, 2021

(54) Reducing waiting times using queuing networks

(71) Applicant: Saudi Arabian Oil Company, Dhahran (SA)

(72) Inventors: Serkan Dursun, Dhahran (SA); Wael Al-Saeed, Dhahran (SA); Balakoteswara R Koppuravuri, Al-Khubar (SA); Ibrahim Alabdulmohsin, Al-Khubar (SA)

(21) Appl. No.: 17/007,535

(22) Filed: Aug. 31, 2020

Related U.S. Application Data
(60) Provisional application No. 62/906,467, filed on Sep. 26, 2019.

(51) Int. Cl. G06Q 50/28; G06Q 30/02; G06Q 10/06; G06Q 30/00; G06N 20/00; G01C 21/34

(52) U.S. Cl. CPC G06Q 50/28; G06Q 30/0201; G01C 21/3407; G06Q 30/018; G06N 20/00; G06Q 10/06315

(57) ABSTRACT

Systems and methods for managing deliveries to a hydrocarbon storage system that includes a plurality of hydrocarbon storage facilities include a first machine-learning model for each individual hydrocarbon storage facility that predicts truck-waiting times and sales volumes and a second machine-learning model for the hydrocarbon storage system that outputs a recommended hauling volume for each individual hydrocarbon storage facility.

### CLAIM OF PRIORITY

This application claims priority under 35 USC § 119(e) to U.S. Patent Application Ser. No. 62/906,467, filed on Sep. 26, 2019, the entire contents of which are hereby incorporated by reference.

### TECHNICAL FIELD

The present disclosure generally relates to the field of predictive modeling and adaptive control systems, particularly systems and methods for predicting the behavior of complex queuing systems using historical data.

### BACKGROUND

Machine-learning uses algorithms and statistical models to enable computer systems to perform a specific task without using explicit instructions, relying on patterns and inference instead. Machine-learning algorithms build a mathematical model based on sample data in order to make predictions or decisions without being explicitly programmed to perform the specific task. Machine-learning algorithms are used in a wide variety of applications, such as email filtering and computer vision, where it is difficult or infeasible to develop a conventional algorithm for effectively performing the task.

Queueing theory is the mathematical study of waiting lines, or queues in which a model is constructed to predict queue lengths and waiting times. Queueing theory is generally considered a branch of operations research because the results are often used when making business decisions about the resources needed to provide a service. Queueing theory and systems are applied in fields including telecommunication, traffic engineering, project management, and logistics.

### SUMMARY

This specification describes systems and methods for improving queuing networks using model predictive control with the goal of reducing waiting times while maintaining inventory within the allowable levels. The system includes a data engine for converting data into an appropriate format for analysis, a data warehouse for combining data from a variety of sources, and a predictive analytics engine for analyzing the data and building models. Historical data is analyzed for a set of storage facilities in real-time. The historical data includes transactional data for discrete events that occur at the set of facilities and non-transactional data spanning continuous time periods. Operation at the facility is monitored, including collecting data including the transactional data and non-transactional data of the facility. The system includes methods for modeling such data to form a stationary time-independent process. Predictive and time-series forecasting models are generated using the processed data on a rolling horizon window to predict the behavior of complex queuing systems. An action at the facility is controlled using the predictive model. The proposed system is adaptive to changing environments.

In some aspects, methods for managing deliveries to a hydrocarbon storage system that includes a plurality of hydrocarbon storage facilities include: developing a first machine-learning model for each individual hydrocarbon storage facility that predicts truck-waiting times and sales volumes based on parameters that include opening volume, hauling volume, and sales volume data of the individual hydrocarbon storage facility; developing a second machine-learning model for the hydrocarbon storage system that outputs a recommended hauling volume for each individual hydrocarbon storage facility based on parameters that include the truck-waiting times and sales volumes for each individual hydrocarbon storage facility and the average truck-wait time for the hydrocarbon storage system; applying each of the first machine-learning models to current data from an associated hydrocarbon storage facility to predict truck-waiting times and sales volumes for the associated hydrocarbon storage facility; and providing the predicted truck-waiting times and sales volumes for each hydrocarbon storage facility as input to the second machine learning model to generate the recommended hauling volume for each individual hydrocarbon storage. Embodiments of these methods can include one or more of the following features.

In some embodiments, methods also include sending routing instructions to individual trucks.

In some embodiments, methods also include updating the opening volume, hauling volume, and sales volume data of the individual hydrocarbon storage facilities by incorporating collected facility data on an ongoing basis. In some cases, methods also include updating the machine-learning model on an ongoing basis based a set time period of updated historical data. In some cases, methods also include updating truck-waiting time and sales volume of the hydrocarbon storage system by incorporating collected system data on an ongoing basis.

In some embodiments, developing the first machine-learning model comprises collecting historical data for the individual hydrocarbon storage facility.

In some aspects, systems for managing deliveries to a hydrocarbon storage system that includes a plurality of hydrocarbon storage facilities include: a first machine-learning model for each individual hydrocarbon storage facility that predicts truck-waiting times and sales volumes based on parameters that include opening volume, hauling volume, and sales volume data of the individual hydrocarbon storage facility; a second machine-learning model for the hydrocarbon storage system that outputs a recommended hauling volume for each individual hydrocarbon storage facility based on parameters that include the truck-waiting times and sales volumes for each individual hydrocarbon storage facility and the average truck-wait time for the hydrocarbon storage system; and a communications system operable to send routing instructions to individual trucks.

In some embodiments, systems include at least one graphical user interface (GUI) and a web browser operating on a client machine.

In some embodiments, systems include a server hosting the first machine-learning model and the second machine-learning model.

In some embodiments, systems include database on the server holding historical data regarding each individual hydrocarbon storage facility. In some cases, the historical data comprises opening volume, hauling volume, and sales volume data of each the individual hydrocarbon storage facility.

In some embodiments, the second machine-learning model is an optimization model that optimizes average waiting time or average queue.

Predictive analytics refers to the use of machine-learning and applied statistics to predict unknown conditions based on the available data. Two general domains that fall under predictive analytics are classification and regression.

In predictive analytics, there are unknown variables y [symbol] which depend (either directly or indirectly) on a set of known predictors x [symbol] . In the systems and methods described in this specification, the predictors x [symbol] (also called attributes or features) are known to the system but the values of the variables y [symbol] are unknown. The system predicts the values of the unknown variables upon observing the known predictors.

One example of predictive analytics is to predict the waiting time of trucks in a loading/offloading facility. The list of known variables may include, but are not limited to, hauling volumes, sale volumes, and operating inventory levels, for each product in the facility. One example of an unknown variable is the average waiting time of the arriving trucks at the facility in the future for both loading and offloading.

The appropriate prediction algorithm can differ from one application to another. For classification, examples of prediction algorithms include support vector machine, logistic regression, decision trees, nearest neighbor methods, and neural networks. For regression, popular algorithms include least squares regression, Lasso, and radial basis function (RBF) networks. The performance of each algorithm depends on various factors, such as the choice of the predictors, hyper-parameters, and the training/validation method. As such, predictive analytics is not an automatic task, but an iterative process of knowledge discovery or interactive multi-objective optimization that involves trial and error. It is often necessary to modify data preprocessing and model parameters until the result achieves the desired properties.

Predictive analytics is commonly branded under the category of “supervised learning” methods because a “correct” answer is always available. The system's goal is to answer questions correctly. By contrast, unsupervised learning methods, such as clustering, do not have a well-defined measure of success since a “correct” answer is not always known.

Queuing systems include three fundamental components. First, servers provide a required service, such as to load or offload products. Second, users arrive at the facility to receive the service. For examples, this includes trucks that carry the product to be loaded or offloaded. Third, an inventory contains the products, such as a storage tank. A queuing system may contain multiple types of products.

In this context, the term “servers” includes individuals or entities that provide a required service or services. The term “user” refers to any user of a system including individuals, organizations, corporations, associations, and other entities that provide activities related to inventory management and distribution associated with the required service.

Queuing systems can be complex in practice. For example, a single server is sometimes dedicated to serving multiple types of products but not all, and the set of products differ from one server to the next within the same queuing system. In addition, different servers may handle similar products but the full list of products they handle may not be identical. As such, traditional mathematical techniques for predicting the behavior of queuing systems do not apply.

Queue measurement systems are designed to help facilities in at least two ways. Such systems can improve customer service by reducing user's waiting time. Such systems can also improve the efficiency of operations at the facilities and reduce costs by reducing the system size. Predictive analytics enable queue management systems to predict the behavior of complex queuing systems, such as the average waiting time and average queue length, when different types of workers are served by different types of servers, while also managing the inventory levels of different products.

Facilities that benefit from the application of model predictive control for managing queuing systems include storage facilities including hydrocarbon storage facilities such as bulk plants and oil shipping terminals. A bulk plant is a facility used for the temporary bulk storage of gasoline, diesel fuel and similar liquid refined products, prior to the distribution of these products to retail outlets. Other facilities that benefit from the application of model predictive control for managing queuing systems include warehouses, which provide a temporary storage of goods before they are redistributed to consumers. The application of model predictive control for managing queuing systems can also benefit shipping terminals, for example, shipping terminals that export products overseas. The inflow to such terminals include products to be exported that are stocked in temporary storage areas, such tank farms. The outflow is the cargo loaded to ships for export.

The systems and methods described in this specification do not rely on assumptions regarding the distributions of inter-arrival times, service times, and number of service events. This approach provides a significant advantage over queueing theory based systems that rely on assumptions of the distributions of inter-arrival times, service times, and number of service, as defined by the Kendall notation. This difference is significant because these parameters, particularly inter arrival times and service times often do not follow any probability distribution.

These systems and methods do not require analysis of the structure and architecture of the plants being manages. Rather, these systems and methods generate a predictive model based on statistical features extracted from the historical time series data of hauling volume, sale volume, and inventory in a bulk plant. The model captures the dynamics behavior of the system without depending on time.

The details of one or more embodiments of these systems and methods are set forth in the accompanying drawings and the description to be presented. Other features, objects, and advantages of these systems and methods will be apparent from the description and drawings, and from the claims.

### DESCRIPTION OF DRAWINGS

FIG. 1 is a schematic illustration of a bulk plant.

FIG. 2 is schematic illustration of a storage tank at the bulk plant of FIG. 1.

FIG. 3 is a chart plotting opening inventory, hauling volume, sales volume, and waiting times over time at a bulk plant.

FIG. 4 is chart illustrating an example probability density function of the waiting time of a truck at a facility.

FIG. 5 illustrates a process flow diagram for implementing systems and methods for calculating waiting time for a truck at a facility.

FIGS. 6A and 6B show the performance of a predictive model for calculating waiting time for a truck at a facility on a training dataset and a test dataset, respectively.

FIG. 7 is a block diagram illustrating an example computer system used to provide computational functionalities associated with described algorithms, methods, functions, processes, flows, and procedures as described in the present disclosure, according to some implementations of the present disclosure.

Like reference symbols in the various drawings indicate like elements.

### DETAILED DESCRIPTION

This specification describes systems and methods for predicting the behavior of complex queuing systems in response to known input parameters, such as inventory levels and inflow rate, and for choosing the actions to optimize figures of merit, such as average waiting time and average queue length. These systems and methods can improve queuing networks using model predictive control with the goal of reducing waiting times while maintaining inventory within the allowable levels. The system relies on predictive analytics and is data-driven. It generates a predictive model for the behavior of queuing systems that are too complex to model using traditional techniques such as mathematical analysis. Examples of predicted variables include the average waiting time, closing inventory level, and average system size.

The system includes a data engine for converting data into an appropriate format for analysis, a data warehouse for combining data from a variety of sources, and a predictive analytics engine for analyzing the data and building models. Historical data is analyzed for a set of storage facilities in real-time. The historical data includes transactional data for discrete events that occur at the set of facilities and non-transactional data spanning continuous time periods. Operation at the facility is monitored, including collecting data including the transactional data and non-transactional data of the facility. The system includes methods for modeling such data to form a stationary time-independent process. Predictive and time-series forecasting models are generated using the processed data on a rolling horizon window to predict the behavior of complex queuing systems. The predictive models can be used in controlling actions and operations at an operating facility. For example, the inflow rate of products (also known as hauling) at the operating facility can be controlled based on output of the predictive model. The proposed system is adaptive to changing environments.

In one embodiment, the system predicts the average waiting time of hauling trucks at bulk plants as well as the closing inventory levels as a function of the inflow rate of products, the outflow rate, and the inventory levels. The system incorporates an individual machine learning model for each bulk plant (a first machine learning model). The system is agnostic to the structure of the queuing network inside the bulk plant. The relation between predictors and output is captured by combining the historical data on a rolling horizon over a fixed number of days. As such, the same system can be applied to multiple bulk plants that do not necessarily share the same queuing structure. The output from the first machine learning model for each bulk plant is provided as input to a second machine learning model that outputs a recommended hauling volume for each individual hydrocarbon storage facility based on parameters that include the truck-waiting times and sales volumes for each individual hydrocarbon storage facility and the average truck-wait time for the hydrocarbon storage system.

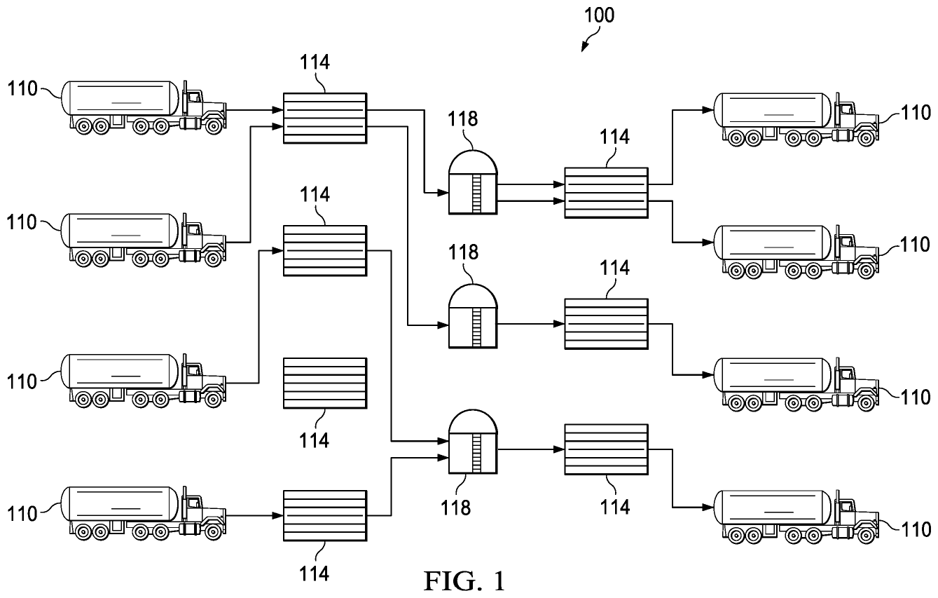

FIG. 1 illustrates the process including inflow (supply) and outflow (demand) in a bulk plant 100. Trucks 110 operated by hauling companies supply products (for example, crude oil, gasoline, and diesel fuel) to the bulk plant 100 from the nearby port facilities. At the bulk plant 100, these products are loaded into the storage tanks 114 through the automated bays 118 installed in the plant 100. Some but not necessarily all of the bays 118 can handle multiple products at the same time as needed. Products are transported from the bulk plant 100 to the retail customers (sales) by trucks 110 operated by individual customers who are buying the products. The storage tanks 114 have limited capacity that can result in long waiting times for trucks 110 operated by hauling companies to off-load their product if sales are low. The complexity of the system includes predicting the sales and minimizing the waiting time of trucks operated by the hauling companies.

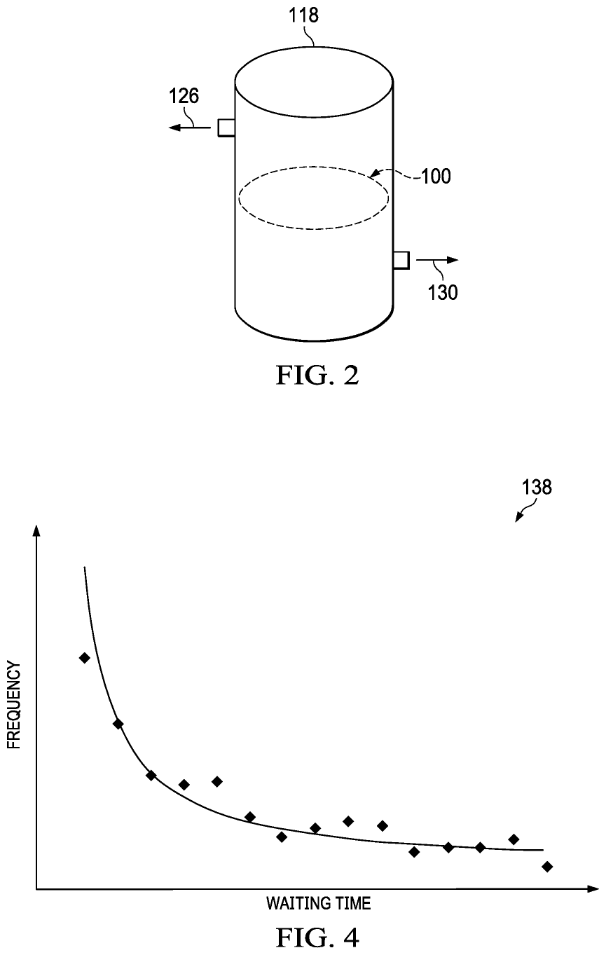

FIG. 2 depicts a storage tank 118 in the bulk plant 100. Opening inventory 122 designates the inventory at the start of the day. Products shipped through the hauling trucks constitute the inflow 126 into the tank and sales 130 represent the outflow from the tank. For both the plant and individual tanks, mass balance indicates that current inventory is opening inventory 122 plus inflow 126 minus sales 130. The current inventory changes over time.

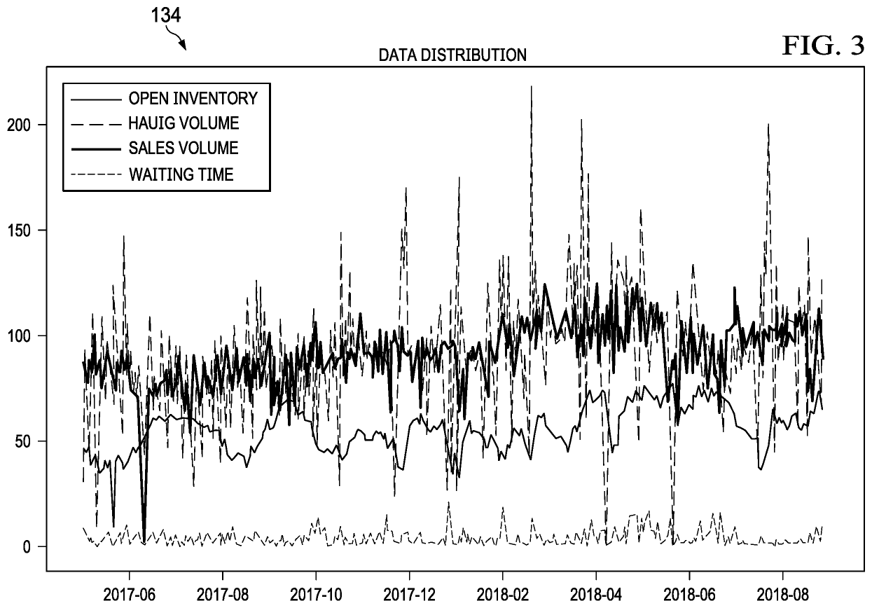

FIG. 3 is a chart 134 plotting opening inventory, hauling volume, sales volume, and waiting times over time at a bulk plant. The chart 134 illustrates how volumes of hauling, sales, waiting times, and opening inventory level can vary significantly over time. These are not constant so predicting them in advance is crucial for the task of controlling the queuing system effectively.

FIG. 4 is chart 138 illustrating an example probability density function (PDF) of the waiting time of a truck at a facility.

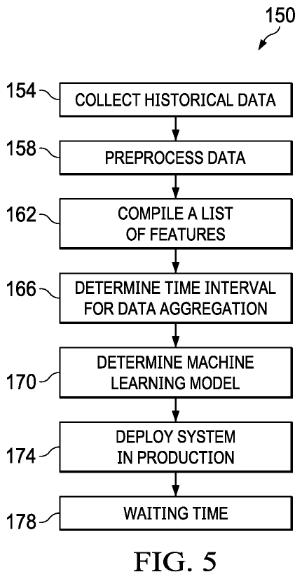

FIG. 5 illustrates a flow diagram of a process 150 for implementing systems and methods for modeling queueing systems. The process 150 is described in the context of a bulk plant but can also be used for implementing systems and methods for modeling queueing systems for other facilities, for example, warehouses and shipping terminals.

The first stage 154 of the process 150 is collecting historical data. In one embodiment, the data form a time series that includes hauling volumes, sales volumes, opening inventory levels, and average waiting times. The data provides information about the time waited by the truck and the amount of the product carried by the truck. Other embodiments may include other data sources, such as the number of waiting trucks, in-transit trucks, and queue length at several sampled points of time.

The second stage 158 is preprocessing the data. For a given date, several trucks arrive and products are discharged into the tanks through the bays. Data preprocessing task may include outlier removal, handling missing values, and aggregating records, such as by day, plant, and product.

The third stage 162 is to compiling a list of features that can be fed into the predictive model. In one embodiment, the features are aggregated quantities of hauling volume, sales volume, and opening inventory. In some embodiments, truck counts and average waiting times are also included. The time series feature generation includes sliding window of the recent most values in hauling volume, sales volume, opening inventory, truck counts and waiting time.

The fourth stage 166 is determining the time interval (sampling interval) for data aggregation. This involves choosing the aggregation time for selected features by finding the length of the sliding window that results in an improved predictive model. Different features may have different sampling intervals.

The fifth stage 170 is developing the machine-learning algorithm. The best machine-learning algorithm and the corresponding hyper-parameters are determined. The list of algorithms include but not limited all supervised regression modeling such as linear regression, MLP, SVR, Deep Learning ANN, Ensemble models (Random Forest, GBM, XGBOOST)

The final stage 174 is deployment. The model is deployed in a production environment with a front-end visualization. In one embodiment, the user interacts with the system through a graphical user interface (GUI) and a web browser operating on the client machine. The processing and modeling are executed on a server that has direct access to all historical data. The predictive model is then used as an input to an optimization model that optimizes figures of interest, such as average waiting time or average queue 178.

For example, this approach can be used in predicting the daily sales (demand) and expected waiting time of the hauling trucks at different bulk plants. This information provides the basis for allocating hauling quantities between multiple bulk plants.

The process 150 was used to develop a prototype of the process 200 based on the system 250. In the prototype, a visualization layer displays the predicted variables such as sales for tomorrow, recommended hauling volume and waiting time. In addition, the visualization layer includes current utilization of the bulk plant (facility) in terms of how many hauling trucks been received and volume of sales been made. Facility operators can download the data, for example, into Excel and generate custom detailed reports per their requirements as a self-service.

The proposed system is adaptive to the dynamics of the business operation of the bulk plants. The model in the prototype can be configured to update training based on the most recent historical data. This approach enables the model to learn adaptively and reflect changes in the environment of the operation.

These systems and methods can be implemented with variations to the approach described above. For example, the features may be pre-processed, normalized, or subjected to feature-selection processes. Regularization terms can also be added into the machine-learning model to further mitigate the risk of over-fitting. The choice of the hyper-parameters can be made via cross-validation, leave-one-out estimation, or any other model selection method.

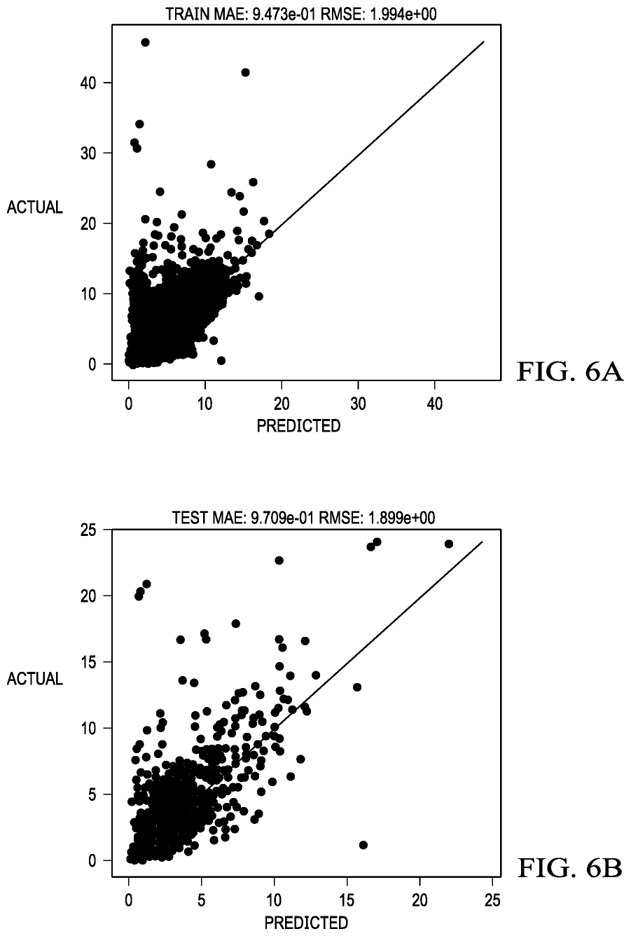

FIGS. 6A and 6B show the performance of a predictive model for calculating waiting time for a truck at a facility on a training dataset and a test dataset, respectively. The x-axis corresponds to the predicted values while the y-axis corresponds to the actual values. The training dataset was used to calibrate the model and the test dataset was used to check the calibration. A linear fit of the data was performed. The slope of the linear fir of the data from the test dataset indicates that the prototype system can predict the waiting times accurately.

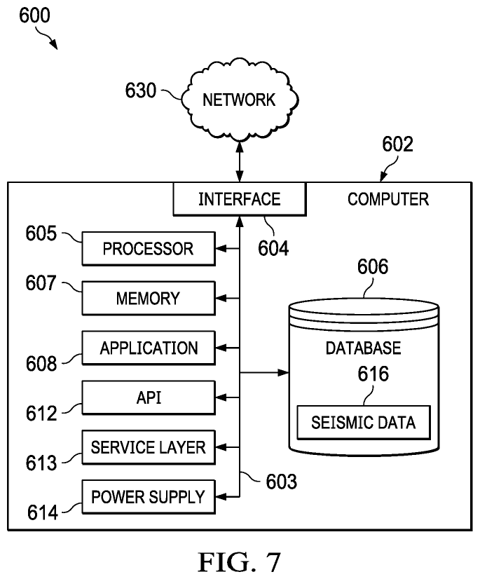

FIG. 7 is a block diagram of an example computer system 600 used to provide computational functionalities associated with described algorithms, methods, functions, processes, flows, and procedures described in the present disclosure, according to some implementations of the present disclosure. The illustrated computer 602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 602 can include input devices such as keypads, keyboards, and touch screens that can accept user information. Also, the computer 602 can include output devices that can convey information associated with the operation of the computer 602. The information can include digital data, visual data, audio information, or a combination of information. The information can be presented in a graphical user interface (UI) (or GUI).

The computer 602 can serve in a role as a client, a network component, a server, a database, a persistency, or components of a computer system for performing the subject matter described in the present disclosure. The illustrated computer 602 is communicably coupled with a network 630. In some implementations, one or more components of the computer 602 can be configured to operate within different environments, including cloud-computing-based environments, local environments, global environments, and combinations of environments.

At a high level, the computer 602 is an electronic computing device operable to receive, transmit, process, store, and manage data and information associated with the described subject matter. According to some implementations, the computer 602 can also include, or be communicably coupled with, an application server, an email server, a web server, a caching server, a streaming data server, or a combination of servers.

The computer 602 can receive requests over network 630 from a client application (for example, executing on another computer 602). The computer 602 can respond to the received requests by processing the received requests using software applications. Requests can also be sent to the computer 602 from internal users (for example, from a command console), external (or third) parties, automated applications, entities, individuals, systems, and computers.

Each of the components of the computer 602 can communicate using a system bus 603. In some implementations, any or all of the components of the computer 602, including hardware or software components, can interface with each other or the interface 604 (or a combination of both), over the system bus 603. Interfaces can use an application programming interface (API) 612, a service layer 613, or a combination of the API 612 and service layer 613. The API 612 can include specifications for routines, data structures, and object classes. The API 612 can be either computer-language independent or dependent. The API 612 can refer to a complete interface, a single function, or a set of APIs.

The service layer 613 can provide software services to the computer 602 and other components (whether illustrated or not) that are communicably coupled to the computer 602. The functionality of the computer 602 can be accessible for all service consumers using this service layer. Software services, such as those provided by the service layer 613, can provide reusable, defined functionalities through a defined interface. For example, the interface can be software written in JAVA, C++, or a language providing data in extensible markup language ( XML) format. While illustrated as an integrated component of the computer 602, in alternative implementations, the API 612 or the service layer 613 can be stand-alone components in relation to other components of the computer 602 and other components communicably coupled to the computer 602. Moreover, any or all parts of the API 612 or the service layer 613 can be implemented as child or sub-modules of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602 and the described functionality. The interface 604 can be used by the computer 602 for communicating with other systems that are connected to the network 630 (whether illustrated or not) in a distributed environment. Generally, the interface 604 can include, or be implemented using, logic encoded in software or hardware (or a combination of software and hardware) operable to communicate with the network 630. More specifically, the interface 604 can include software supporting one or more communication protocols associated with communications. As such, the network 630 or the hardware of the interface can be operable to communicate physical signals within and outside of the illustrated computer 602.

The computer 602 includes a processor 605. Although illustrated as a single processor 605 in FIG. 6, two or more processors 605 can be used according to particular needs, desires, or particular implementations of the computer 602 and the described functionality. Generally, the processor 605 can execute instructions and can manipulate data to perform the operations of the computer 602, including operations using algorithms, methods, functions, processes, flows, and procedures as described in the present disclosure.

The computer 602 also includes a database 606 that can hold data (for example, seismic data 616) for the computer 602 and other components connected to the network 630 (whether illustrated or not). For example, database 606 can be an in-memory, conventional, or a database storing data consistent with the present disclosure. In some implementations, database 606 can be a combination of two or more different database types (for example, hybrid in-memory and conventional databases) according to particular needs, desires, or particular implementations of the computer 602 and the described functionality. Although illustrated as a single database 606 in FIG. 6, two or more databases (of the same, different, or combination of types) can be used according to particular needs, desires, or particular implementations of the computer 602 and the described functionality. While database 606 is illustrated as an internal component of the computer 602, in alternative implementations, database 606 can be external to the computer 602.

The computer 602 also includes a memory 607 that can hold data for the computer 602 or a combination of components connected to the network 630 (whether illustrated or not). Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same, different, or combination of types) can be used according to particular needs, desires, or particular implementations of the computer 602 and the described functionality. While memory 607 is illustrated as an internal component of the computer 602, in alternative implementations, memory 607 can be external to the computer 602.

The application 608 can be an algorithmic software engine providing functionality according to particular needs, desires, or particular implementations of the computer 602 and the described functionality. For example, application 608 can serve as one or more components, modules, or applications. Further, although illustrated as a single application 608, the application 608 can be implemented as multiple applications 608 on the computer 602. In addition, although illustrated as internal to the computer 602, in alternative implementations, the application 608 can be external to the computer 602.

The computer 602 can also include a power supply 614. The power supply 614 can include a rechargeable or non-rechargeable battery that can be configured to be either user- or non-user-replaceable. In some implementations, the power supply 614 can include power-conversion and management circuits, including recharging, standby, and power management functionalities. In some implementations, the power-supply 614 can include a power plug to allow the computer 602 to be plugged into a wall socket or a power source to, for example, power the computer 602 or recharge a rechargeable battery.

There can be any number of computers 602 associated with, or external to, a computer system containing computer 602, with each computer 602 communicating over network 630. Further, the terms “client,” “user,” and other appropriate terminology can be used interchangeably, as appropriate, without departing from the scope of the present disclosure. Moreover, the present disclosure contemplates that many users can use one computer 602 and one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

What is claimed is:

1. A method for managing deliveries to a hydrocarbon storage system that includes a plurality of hydrocarbon storage facilities, the method comprising:
developing a first machine-learning model for each individual hydrocarbon storage facility that predicts truck-waiting times and sales volumes based on parameters that include opening volume, hauling volume, and sales volume data of the individual hydrocarbon storage facility;
developing a second machine-learning model for the hydrocarbon storage system that outputs a recommended hauling volume for each individual hydrocarbon storage facility based on parameters that include the truck-waiting times and sales volumes for each individual hydrocarbon storage facility and the average truck-wait time for the hydrocarbon storage system;
applying each of the first machine-learning models to current data from an associated hydrocarbon storage facility to predict truck-waiting times and sales volumes for the associated hydrocarbon storage facility; and
providing the predicted truck-waiting times and sales volumes for each hydrocarbon storage facility as input to the second machine learning model to generate the recommended hauling volume for each individual hydrocarbon storage.

2. The method of claim 1, further comprising sending routing instructions to individual trucks.

3. The method of claim 1, further comprising updating the opening volume, hauling volume, and sales volume data of the individual hydrocarbon storage facilities by incorporating collected facility data on an ongoing basis.

4. The method of claim 3, further comprising updating the machine-learning model on an ongoing basis based a set time period of updated historical data.

5. The method of claim 3, further comprising updating truck-waiting time and sales volume of the hydrocarbon storage system by incorporating collected system data on an ongoing basis.

6. The method of claim 1, wherein developing the first machine-learning model comprises collecting historical data for the individual hydrocarbon storage facility.

7. A method for managing deliveries to a hydrocarbon storage system that includes a plurality of hydrocarbon storage facilities, the method comprising:
developing a first machine-learning model for each individual hydrocarbon storage facility that predicts truck-waiting times and sales volumes based on parameters that include opening volume, hauling volume, and sales volume data of the individual hydrocarbon storage facility;
developing a second machine-learning model for the hydrocarbon storage system that outputs a recommended hauling volume for each individual hydrocarbon storage facility based on parameters that include the truck-waiting times and sales volumes for each individual hydrocarbon storage facility and the average truck-wait time for the hydrocarbon storage system;
applying at least one of the first machine-learning models to current data from an associated hydrocarbon storage facility to predict truck-waiting times and sales volumes for the associated hydrocarbon storage facility;
providing the predicted truck-waiting times and sales volumes for the at least one hydrocarbon storage facility as input to the second machine learning model to generate the recommended hauling volume for each individual hydrocarbon storage; and
sending routing instructions to individual trucks.

8. The method of claim 7, further comprising updating the opening volume, hauling volume, and sales volume data of the individual hydrocarbon storage facilities by incorporating collected facility data on an ongoing basis.

9. The method of claim 8, further comprising updating the machine-learning model on an ongoing basis based a set time period of updated historical data.

10. The method of claim 8, further comprising updating truck-waiting time and sales volume of the hydrocarbon storage system by incorporating collected system data on an ongoing basis.

11. The method of claim 7, wherein developing the first machine-learning model comprises collecting historical data for the individual hydrocarbon storage facility.

12. A system for managing deliveries to a hydrocarbon storage system that includes a plurality of hydrocarbon storage facilities, the system comprising:
a first machine-learning model for each individual hydrocarbon storage facility that predicts truck-waiting times and sales volumes based on parameters that include opening volume, hauling volume, and sales volume data of the individual hydrocarbon storage facility;
a second machine-learning model for the hydrocarbon storage system that outputs a recommended hauling volume for each individual hydrocarbon storage facility based on parameters that include the truck-waiting times and sales volumes for each individual hydrocarbon storage facility and the average truck-wait time for the hydrocarbon storage system; and
a communications system operable to send routing instructions to individual trucks.

13. The system of claim 12, further comprising at least one graphical user interface (GUI) and a web browser operating on a client machine.

14. The system of claim 12, further comprising a server hosting the first machine-learning model and the second machine-learning model.

15. The system of claim 12, further comprising a database on the server holding historical data regarding each individual hydrocarbon storage facility.

16. The system of claim 15, wherein the historical data comprises opening volume, hauling volume, and sales volume data of each the individual hydrocarbon storage facility.

17. The system of claim 12, wherein the second machine-learning model is an optimization model that optimizes average waiting time or average queue.

18. A system for managing deliveries to a hydrocarbon storage system that includes a plurality of hydrocarbon storage facilities, the system comprising:
a communications device;
at least one processing device in communication with the communications device; and
a memory storing instructions that, when executed by the at least one processing device, cause the at least processing device to perform operations comprising:
developing a first machine-learning model for each individual hydrocarbon storage facility that predicts truck-waiting times and sales volumes based on parameters that include opening volume, hauling volume, and sales volume data of the individual hydrocarbon storage facility;
developing a second machine-learning model for the hydrocarbon storage system that outputs a recommended hauling volume for each individual hydrocarbon storage facility based on parameters that include the truck-waiting times and sales volumes for each individual hydrocarbon storage facility and the average truck-wait time for the hydrocarbon storage system;
applying at least one of the first machine-learning models to current data from an associated hydrocarbon storage facility to predict truck-waiting times and sales volumes for the associated hydrocarbon storage facility;
providing the predicted truck-waiting times and sales volumes for the at least one hydrocarbon storage facility as input to the second machine learning model to generate the recommended hauling volume for each individual hydrocarbon storage; and
sending, by the communications device, routing instructions to individual trucks.

19. The system of claim 18, the operations further comprising updating the opening volume, hauling volume, and sales volume data of the individual hydrocarbon storage facilities by incorporating collected facility data on an ongoing basis.

20. The system of claim 19, the operations further comprising updating the machine-learning model on an ongoing basis based a set time period of updated historical data.
